(19) United States
(12) Patent Application Publication
(10) Pub. No.: US 2023/0294358 A1
(43) Pub. Date: Sep. 21, 2023

(54) 3D PRINTING WITH MOVABLE SLURRY DISPENSER

(71) Applicant: Hewlett-Packard Development Company, L.P., Spring, TX (US)

(72) Inventors: Thomas Anthony, Palo Alto, CA (US); Ben Pon, Palo Alto, CA (US); Lihua Zhao, Palo Alto, CA (US); David A. Champion, Corvallis, OR (US)

(73) Assignee: Hewlett-Packard Development Company, L.P., Spring, TX (US)

(21) Appl. No.: 17/791,548

(22) PCT Filed: Feb. 12, 2020
(86) PCT No.: PCT/US2020/017959

§ 371 Date: Jul. 8, 2022

(51) Int. Cl. B29C 64/236; B29C 64/209; B29C 64/165; B29C 64/232; B29C 64/214; B29C 64/35; B33Y 30/00; B33Y 40/00

(52) U.S. Cl. CPC B29C 64/236; B29C 64/209; B29C 64/165; B29C 64/232; B29C 64/214; B29C 64/35; B33Y 30/00; B33Y 40/00

(57) ABSTRACT

A three-dimensional (3D) printing system may include a build volume, a slurry reservoir to contain a slurry of build material and liquid, and a slurry dispenser to receive the slurry from the slurry reservoir and movable in a direction across the build volume to dispense slurry across the build volume.

### BACKGROUND

Three-dimensional printing systems, also referred to as additive manufacturing systems, facilitate the generation of three-dimensional (3D) objects on a layer-by-layer basis. Such 3D printing techniques generate each layer of an object by spreading build material across a build volume and selectively solidifying portions of the layer.

### BRIEF DESCRIPTION OF THE DRAWINGS

FIG. 1 is a side view of portions of an example 3D printing system.

FIG. 2 is a side view of portions of an example 3D printing system.

FIG. 3 is a flow diagram of an example 3D printing layer generation method.

FIG. 4 is a sectional view illustrating portions of an example 3D printing system.

FIG. 5 is a perspective view illustrating portions of an example 3D printing system.

FIG. 6 is a sectional view illustrating portions of an example 3D printing system.

FIG. 7 they sectional view illustrating portions of an example 3D printing system.

FIG. 8 is a sectional view illustrating portions of an example 3D printing system.

FIG. 9 is a sectional view illustrating portions of an example 3D printing system.

FIG. 10 is a sectional view illustrating portions of an example 3D printing system.

FIG. 11 is a sectional view illustrating portions of an example 3D printing system.

FIG. 12 is a sectional view illustrating portions of an example 3D printing system.

FIG. 13 is a perspective view of an example pair of mirroring slurry dispensers.

FIG. 14 is a sectional view illustrating portions of an example 3D printing system.

FIG. 15 is a top view schematically illustrating portions of an example 3D printing system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example 3D printing systems and methods that may facilitate more accurate printing of three-dimensional objects from a wide array of build materials. The example 3D printing systems and methods print three-dimensional objects by forming the objects on a layer by layer basis. Each layer is formed by a slurry of a liquid and a build material. The slurry may facilitate enhanced packing of the individual build material particles. High packing density may lead to stronger green parts (a higher density of contact points) and may facilitate void removal during sintering.

Forming layers of a 3D printed object from a slurry may be especially beneficial when printing with smaller particles, such as metal or other particles having a mean particle size of less than 10 μm. Such smaller particles may sinter more readily as compared to larger particles. However, when being spread as a dry powder to form a layer, van der Waals and frictional forces may inhibit the small particles from settling into a high packing density. As a result, the layer may become more loosely packed or defective. When spread as part of a dry powder to form a layer, such smaller particles are more likely to become airborne, potentially triggering more frequent equipment maintenance. Because the example 3D printing systems and methods form the layers of the object being printed from a dispensed slurry, rather than a dry powder, the small particles are less likely to become airborne and are more likely to settle into a high packing density.

The example 3D printing systems and methods dispense the slurry of build material and liquid from a slurry dispenser as the slurry dispenser is moved across a build bed or build volume of a 3D printer. Dispensing the slurry from a translating or moving dispenser, rather than from a static dispenser at a side or end of the build volume and then spreading or grading the slurry across the build volume, reduces or eliminates liquid loss and the associated viscosity increases that may occur during such prolonged spreading. In some implementations, a leveler further levels the slurry dispensed by the moving slurry dispenser. In some implementations, the slurry dispenser is bidirectional in that it dispenses slurry while moving in either direction across the build volume. In some implementations, different levelers are provided for leveling the dispensed slurry depending upon the direction in which the slurry dispenser is moving.

In those implementations that include levelers, a residue of the slurry may remain on a blade surface or other leveling surface of the leveler. In such implementations, wipers may be provided to clean or remove the residue from the leveling surface. In some implementations, the leveling surface is moved across the wipers. In other implementations, the wipers are moved across the leveling surface. In some implementations, both the wipers and the leveling surfaces are moved relative to one another during cleaning. In some implementations, the leveling surface may be coated with a material that is phobic to the slurry material being dispensed. In some implementations, the levelers may be lowered into an ultrasonic bath where the slurry residue is removed.

In some implementations, the slurry is dispensed through a nozzle, slot or other dispenser aperture. Pumps and valves are utilized to deliver the slurry through the dispenser aperture. The pumps and valves may be operated such that the slurry exits aperture at a pressure of about 100 to 500,000 Pa above atmospheric pressure. In other implementations, the slurry may be dispensed at other pressures depending upon slot or aperture design and the target coating rate. During those times that slurry is not dispensed through the aperture, the aperture may be closed or sealed to inhibit evaporation and drying of the slurry within the dispenser. In some implementations, the aperture itself is selectively openable and closable. In some implementations, a capping device having a compressible sealing face, such as a rubber or rubber-like pad, may be moved into sealing engagement across and over the aperture to close and seal the aperture.

Disclosed is an example 3D printing system. The example 3D printing system may include a build volume, a slurry reservoir to contain a slurry of build material and liquid, and a slurry dispenser to receive the slurry from the slurry reservoir and movable in a direction across the build volume to dispense slurry across the build volume. In some embodiments of the example 3D printing system the slurry reservoir is remotely positioned from the other components of the printing system.

Disclosed is an example 3D printing method. The example method may include moving a slurry dispenser to different locations opposite a build volume, dispensing a slurry of build material and liquid from the slurry dispenser at the different locations and leveling the slurry to form a layer of slurry across the build volume.

Disclosed is an example 3D printing system. The example 3D printing system may include a build volume, a slurry reservoir to contain a slurry of build material and liquid, a slurry dispenser to receive the slurry from the slurry reservoir and movable in a direction across the build volume to dispense slurry across the build volume, a slurry leveler movable across the build volume to level slurry dispensed into the build volume, a build material solidifier and a controller to receive a file for a three-dimensional object to be printed and to control the build material solidifier, the slurry dispenser and the slurry leveler based upon the file.

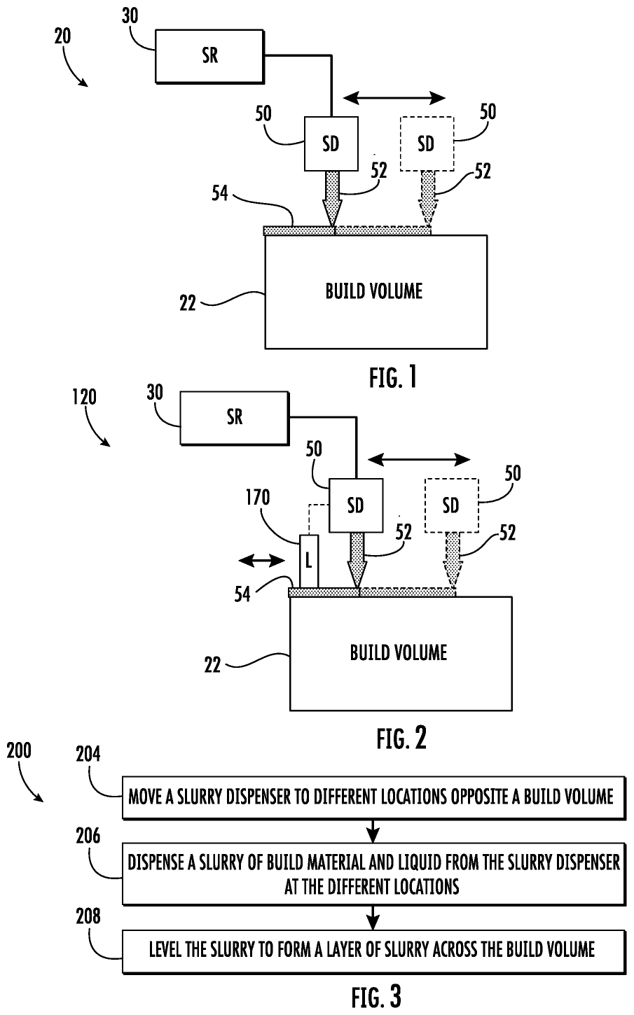

FIG. 1 is a side view schematically illustrating portions of an example 3D printing system 20. 3D printing system 20 forms three-dimensional objects on a layer-by-layer basis. Each layer is formed by dispensing a slurry of build material and liquid from a moving slurry dispenser. As described above, because the build material forming the layer is dispensed as a slurry (in contrast to a dry powder), the build material is less likely to become airborne and more densely packs, enhancing quality of the three-dimensional object being printed. Printing system 20 comprises build volume 22, slurry reservoir 30 and slurry dispenser 50.

Build volume 22, sometimes referred to as a build bed, comprises a chamber to contain the layers of build material deposited by slurry dispenser 50 and selectively solidified or fused to form the three-dimensional part or object.

Slurry reservoir 30 comprises a chamber that is to contain a slurry comprising a mixture of build material or build material particles and a liquid, such as water. In some implementations, the slurry is directed into reservoir 30. In some implementations, the slurry is mixed and formed within reservoir 30. Slurry reservoir 30 supplies slurry to slurry dispenser 50.

Slurry dispenser 50 receives the slurry from slurry reservoir 30 and is movable in a direction across build volume 22 to dispense the slurry across the build volume 22. Slurry dispenser 50 may include a slot, nozzle or other aperture through which the slurry is dispensed. In some implementations, the lower face of the slurry dispenser 50 is spaced from the uppermost surface of the build volume 22 and the previously applied layer 54 such that the dispensed slurry falls under the force of gravity onto the build volume 22. The dispensing of the slurry may be pressurized. In some implementations, the lower face of slurry dispenser 50 is sufficiently close to the uppermost surface of the build volume 22 and the previously applied layer 54 such that the slurry being dispensed is compressed between the lower face of the slurry dispenser 50 and the topmost surface of build volume 22. In such an implementation, the pressure at which the slurry is dispensed may result in enhanced compression of the slurry, forming a more compact layer 54. In one implementation, slurry dispenser 50 is moved or driven by powered actuator such as an electric motor operably coupled to the dispenser 50 by a rotating belt, a hydraulic or pneumatic piston-cylinder assembly, or other mechanisms for linearly translating slurry dispenser 50 over and across build volume 22.

As shown by the example in FIG. 1, as slurry dispenser 50 is moved across build volume 22 (to the position shown in broken lines), slurry dispenser 50 may continuously or intermittently dispense the slurry 52 of build material liquid onto the top of build volume 22, forming a layer 54 of the slurry. In some implementations, the slurry has a viscosity and is dispensed in a controlled fashion such that the layer 54 is level and has a controlled thickness. In some implementations, the slurry 52 dispensed from slurry dispenser 50 may be additionally leveled by separate mechanism. As will be described hereafter, the layer 54 is subsequently selectively solidified by solidifier to form portions of a layer of the 3D object being printed. In some implementations, the layer of slurry may be allowed to at least partially dry prior to being solidified.

FIG. 2 is a side view schematically illustrating portions of an example 3D printing system 120. 3D printing system 120 is similar to 3D printing system 20 described above except that 3D printing system 120 additionally comprises slurry leveler 170. Those remaining components of system 120 which correspond to components of system 20 are numbered similarly.

Slurry leveler 170 comprises a structure having a leveling surface, such as a surface of a blade, that is movable across build volume 22 following the dispensing of slurry 52 onto build volume 22. The leveling surface has a controlled height and surface contour so as to control the thickness and degree of compaction of layer 54. In some implementations, the height may be predetermined and static. In some implementations, the height of slurry leveler 170 may be adjustable. For example, slurry leveler 170 may be telescopically extendable, pivotable or otherwise movable between different heights relative to build volume 22.

In some implementations, slurry leveler 170 may include a vibration generator such that slurry leveler 170 is agitated to further assist in compacting and leveling the dispensed slurry to form layer 54. In some implementations, slurry leveler 174 is movable and is driven across build volume 22 by an actuator or drive mechanism distinct from the actuator or drive mechanism that moves slurry dispenser 50. In some implementations, as shown by broken lines, slurry leveler 170 may be coupled to slurry dispenser 50 so as to move with slurry dispenser 50 across build volume 22. In such an implementation, the actuator that drives slurry dispenser 50 across build volume 22 also drives or moves slurry leveler 170 across build volume 22.

In some implementations, slurry leveler 170 may be located relative to slurry dispenser 50 so as to interact with the newly dispensed slurry from slurry dispenser 50 following a predetermined time lapse from when the slurry was initially dispensed. The predetermined time lapse may be based upon the current viscosity or amount of liquid in the slurry being dispensed. The predetermined amount of time may be chosen such that the slurry has a particular viscosity when interacted upon by slurry leveler 170. In some implementations, slurry leveler 170 may interact with the dispensed slurry almost immediately following the dispensing of the slurry. In some implementations, slurry leveler 170 interacts with the dispensed slurry after the dispensed slurry may have undergone a predetermined amount of drying or evaporation to attain a chosen viscosity.

FIG. 3 is a flow diagram of an example 3D printing method 200. Method 200 forms a layer of build material for forming a layer of a 3D printed object. Method 200 forms a layer by dispensing a slurry of build material and liquid which is leveled prior to the build material being solidified to form the layer of the 3D object. Although method 200 is described in the context of being carried out by system 120, method 200 may be carried out with any of the below described 3D printing systems or with similar 3D printing systems.

As indicated by block 204, a slurry dispenser, such as slurry dispenser 50, is moved to different locations opposite a build volume, such as build volume 22. As indicated by block 206, a slurry of build material and liquid is dispensed from the slurry dispenser at the different locations. The different locations may be a continuum of different locations such that the dispensed slurry forms a continuous, uninterrupted layer of slurry. The different locations may be discontinuous or spaced from one another such that different portions of the build volume 22 have a new layer slurry deposited thereon while other portions omit the new layer of slurry. The selective dispensing of slurry at particular locations across build volume 22 may facilitate faster printing and may conserve build material for those layers of a 3D object that are not to underlie a subsequently formed layer.

As indicated by block 208, the dispensed slurry is leveled through the use of a slurry leveler, such as slurry leveler 170, to form a layer 54 of slurry across the build volume. As noted above, the layer of slurry may be continuous or may intermittently extend across selected portions of the build volume. The thus formed layer of slurry 54 may be further treated or modified or may be otherwise readied for solidification to form the layer of the 3D object.

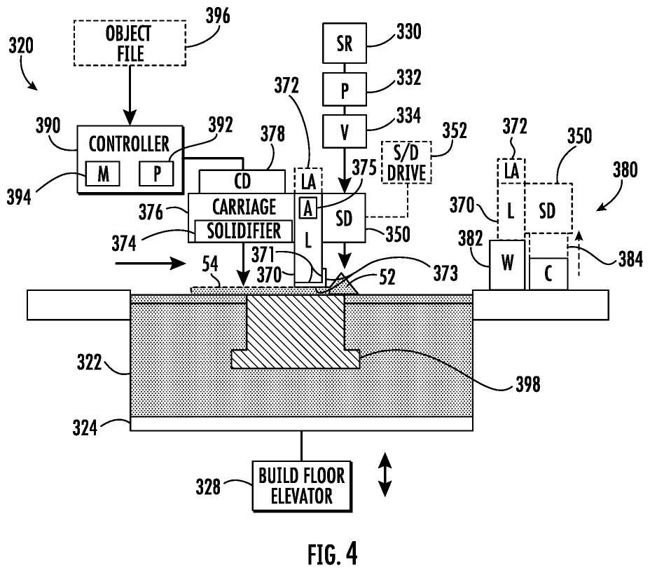

FIG. 4 is a side view schematically illustrating portions of an example 3D printing system 320. FIG. 4 illustrates a particular example of a 3D printing system which pressurizes the slurry being dispensed and which services the slurry dispenser and slurry leveler when not in use. 3D printing system 320 comprises build volume 322, slurry reservoir 330, pump 332, valve 334, slurry dispenser 350, leveler 370, leveler adjuster 372, solidifier 374, carriage 376, carriage drive 378, service station 380 and controller 390.

Build volume 322 is similar to build volume 22 except the build volume 322 is illustrated as additionally comprising a vertically movable floor 324 and a build floor elevator 328. Floor 324 is raised and lowered by build floor elevator 328. Build floor elevator 328 comprises an actuator to raise and lower floor 324 as build volume 322 is being filled with build material on a layer-by-layer basis and as each of the individual layers are selectively solidified by solidifier 374. In one implementation, build floor elevator 328 comprises a motor operably coupled to build floor 324 by a rack and pinion drive to linearly raise and lower floor 324. In other implementations, build floor elevator 328 may comprise other mechanisms for raising and lowering floor 324 in a controlled fashion to control the thickness of the build layers being formed during each pass of slurry dispenser 350 and slurry leveler 370. In some implementations, the thickness of a build layer may be between 10 micrometers and 150 μm.

Slurry reservoir 330 is similar to slurry reservoir 30 described above. Slurry reservoir 330 supplies slurry to pump 332. Pump 332 pumps the slurry through a selectively actuatable valve 334 into slurry dispenser 350 such that the slurry being dispensed by slurry dispenser 350 is dispensed at a pressure of 100 to 500,000 Pa. Dispense rate from the slurry dispenser 350 should be consistent with the desired coating speed and layer thickness. For example, for a coating speed of 10 cm/s and a layer thickness of 100 μm, the dispense rate per cm of coating width may be 1 cm×10 cm/s×100 μm, or 0.1 cm³/s. Controlling the dispense rate involves accurate control of the slurry pressure within the slurry dispenser. Other factors that influence the dispense rate are slurry viscosity and dispenser aperture design. In some implementations, pump 332 may comprise a Beinlich progressive cavity pump wherein valve 334 may comprise a three-way pneumatic valve. In other implementations, pump 332 and valve 334 may comprise other pumping mechanisms and other valve mechanisms to control the pressure of the slurry being supplied through dispenser 350.

Slurry dispenser 350 is similar to slurry dispenser 50 described above. Slurry dispenser 350 comprise a passage or aperture through which the pressurized slurry is dispensed as slurry dispenser 350 is moved across build volume 322. The aperture may be in the form of a nozzle or an elongate slot. In some implementations, an elongate slot may span a majority, if not all, of the width of build volume 322 (which extends perpendicular to the translational direction of slurry dispenser 350). In the example illustrated, slurry dispenser 350 is coupled to carriage 376 so as to be movably driven by carriage drive 378 over and across build volume 322 in unison with the movement of solidifier 374 across build volume 322.

In some implementations, as indicated by broken lines, slurry dispenser 350 may be driven across build 532 by a separate slurry dispenser drive 352 operably coupled to slurry dispenser 350. In some implementations, slurry reservoir 330, pump 332 and/or valve 334 are coupled to slurry dispenser 350 so as to move in unison with slurry dispenser 350 across build volume 322. In some implementations, slurry reservoir 330, pump 332 and/or valve 334 may be remote from slurry dispenser 350 so as to not move with slurry dispenser 350, such as where the slurry is delivered through a flexible tube or conduit to slurry dispenser 350.

Slurry leveler 370 is similar to slurry leveler 70 described above. Slurry leveler 370 comprises a structure having leveling surfaces 371, such as surfaces of a blade, that are movable across build bed 322 following the dispensing of slurry 52 onto build volume 22. In the example illustrated, leveling surfaces 371, which extend along a bottom and side of leveler 370, are coated with a film 373 of material that is phobic to the slurry 52 being dispensed by slurry dispenser 350. As a result, the material of slurry 52 is less likely to stick or adhere to leveling surfaces 371 during leveling. In other implementations, film 373 may be omitted.

The leveling surface has a controlled height and surface contour so as control the thickness and degree of compaction of layer 54. In the example illustrated, the height of slurry leveler 170 is adjustable. For example, slurry leveler 170 may be telescopically extendable, pivotable or otherwise movable between different heights relative to build volume 22. Slurry leveler 170 may be a blade with a leading edge (side of blade facing translation direction) that is beveled. In some implementations, the bevel angle relative to build volume normal is between about 30 and 70 degrees. The lowermost surface of the blade may have a radius or may have a sharp edge. More complex contours also may be employed. For example, the leveler 170 may be a blade with two bevel angles.

Leveler adjuster 372 selectively raises and lowers the lowermost leveling surfaces of leveler 370 relative to the top of build volume 322. Leveler adjuster 370 to facilitate the adjustment of thickness of the formed build layers. Leveler adjuster 370 may further raise leveler 370 when approaching the interior edges or outer frame of build volume 322. In some implementations, leveler adjuster 372 may comprise a hydraulic pneumatic cylinder-piston assembly. In some implementations, leveler adjuster 372 may comprise an electric solenoid. In other implementations, leveler adjuster 372 may comprise a motor which rotates a pinion gear to linearly translate a rack gear connected to leveler 370. In still other implementations, other powered devices may be used to drive the raising and lowering of leveler 370.

In the example illustrated, slurry leveler 370 additionally comprises an agitator 375 in the form of a vibration generator that may be selectively actuated such that slurry leveler 370 is agitated to further assist in compacting and leveling the dispensed slurry to form layer 54.

In the example illustrated, slurry leveler 370 is coupled to both slurry dispenser 370 and carriage 376 so as to be driven relative to and across build volume 322 by carriage drive 378 in unison with slurry dispenser 350 and solidifier 374. In implementations where slurry dispenser 350 is independently driven across build volume 322 by separate and independent slurry dispenser drive 352, slurry leveler 370 may be coupled to slurry dispenser 350 so as to be driven in unison with slurry dispenser 350 across build volume 322 by slurry dispenser drive 352. In implementations where slurry dispenser 350 is independently driven across build volume 322 by a separate and independent slurry dispenser drive 352, slurry leveler 370 may be coupled to carriage 376 so as to be driven across build volume 322 by carriage drive 378. In still other implementations, slurry leveler 370 may be driven across build volume 322 by a separate drive such that leveler 370 is movable across build volume 322 independent of the movement of solidifier 374 and/or dispenser 350 across build volume 322.

In some implementations, slurry leveler 370 may be located relative to slurry dispenser 350 so as to interact with the newly dispensed slurry from slurry dispenser 350 following a predetermined amount of time from when the slurry was initially dispensed. The predetermined amount of time may be based upon the current viscosity or amount of liquid in the slurry being dispensed. The predetermined amount of time may be chosen such that the slurry has a particular viscosity when interacted upon by slurry leveler 370. In some implementations, slurry leveler 170 may interact with the dispensed slurry almost immediately following the dispensing of the slurry. In some implementations, slurry leveler 370 interacts with the dispensed slurry after the dispensed slurry may have undergone a predetermined amount of drying or evaporation to attain a chosen viscosity.

Solidifier 374 carries out solidification of selected portions of the individual layers of build material in build volume 322. In one implementation, solidifier 374 comprises fusing agent deposition and heating systems, binder agent deposition systems, laser sintering systems and the like which operate on the underlying portions of the build layers in build volume 322. In some implementations, solidifier 374 comprises a chemical binding system such as powder bed and inkjet or drop on powder (binder jet 3D printing) system or metal type 3D printing system. In some implementations, solidifier 374 heats the build material to melt the build material to a point of the liquefaction prior to being solidified. In other implementations, solidifier 374 carries out sintering of the build material, wherein the build material is compacted into a solid mass of material by heat or pressure without melting to a point of liquefaction. In some implementations, solidifier 374 dispenses a binder in the form of a latex material, joining the individual build material particles to form the layer of the 3D object without heating.

Carriage 376 comprise a frame movably supporting solidifier 374. Carriage 376 is driven by carriage drive 378. Carriage drive 378 positions solidifier 374 over selected portions of build volume 322. In one implementation, carriage drive 378 may comprise a motor and a rack and pinion drive, an electric solenoid, a hydraulic-pneumatic cylinder a piston assembly or the like to controllably position solidifier 374 to facilitate the solidification of selected portions of the layers of build material in build volume 322. As described above, in some implementations, carriage drive 378 additionally selectively positions and moves slurry dispenser 350 and slurry leveler 370 over build volume 322. In some implementations, the carriage supporting the solidifier may be translated along a direction orthogonal to that of the dispenser and leveler.

In some implementations, solidifier 534 may be stationary, but is capable of interacting with a sufficient area of build volume 322. For example, in some implementations where solidifier 374 carries out selective laser sintering, carriage 376 and carriage drive 378 may be omitted. In such implementations, slurry dispenser 350 and slurry leveler 370 may be driven by the separate slurry dispenser drive 352.

Service station 380 services slurry dispenser 350 and slurry leveler 370 when dispenser 350 and leveler 370 are not in use, such as during solidification of the previously formed layer of slurry and/or when 3D printing system 320 is not being used. Service station 380 extends along a side edge of build volume 322. Service station 380 comprises wiper 382 and capper 384, both of which are schematically illustrated.

Wiper 382 comprises an elastomeric or rubber-like blade or fin projecting upwardly for wiping against at least in underside of leveler 370 as leveler 370 is moved across wiper 382. Wiper 382 may also be provided as a roller that cleans the leveler 370 and/or dispenser 350 by rotating while in contact. The surface of a roller-based wiper 382 may be a brush, a sponge, or a cloth.

Capper 384 comprises an elastomeric or rubber-like pad that is to abut and extends across the aperture of slurry dispenser 350 through which slurry is dispensed. Capper 384 forms a seal across and about the aperture to inhibit drying of the slurry within slurry dispenser 350. In the example illustrated, capper 384 is selectively raised and lowered so as to move the rubber elastomeric pad into and out of engagement with the aperture of dispenser 350. For example, capper 384 may move between a first lower state (shown in solid lines) to a raised state (shown in broken lines) in which capper 384 contacts and engages a bottom of slurry dispenser 350 when slurry dispenser 350 is positioned over capper 384. In other implementations, slurry dispenser 350 may be vertically movable so as to be lowered into sealing contact with capper 384 when dispenser 350 is positioned over capper 384. In some implementations, such as where slurry dispenser 350 comprises a closable dispensing aperture, such as a nozzle or slot, that is closable, capper 384 may be omitted. In some implementations, service station 380 may be omitted.

In some implementations, capper 384 is coupled to, and translates with, slurry dispenser 350. This configuration permits capping of the slurry dispenser independent of dispenser position over the surface of the build volume.

Controller 390 controls the operations of build floor elevator 328, carriage drive 378, slurry dispenser drive 352 (when provided), pump 332, valve 334, leveler adjuster 372, leveler agitator 375, solidifier 374 and capper 384. Controller 390 comprises processing unit 392 and non-transitory computer-readable medium 394. Although controller 390 is illustrated as a single controller, it should be appreciative that operations controlled by controller 390 may be distributed amongst multiple separate controllers.

Processing unit 392 carries out instructions provided in medium 394. Processing unit 392 may receive commands from a user (through an input device), may analyze signals from the various components of system 320 and may output control signals to the various components of system 320 based upon the instructions provided in medium 394. For example, in one implementation, controller 390 may receive an object file 396, such as a computer-aided design (CAD) file. The object file 396 may define a three-dimensional object, such as the example three-dimensional object 398, to be printed within build volume 322. Following instructions contained in memory 394, process 392 may determine individual 3D printing points for each layer of the object 398 to be printed.

For each layer of the 3D object 398 being printed in accordance with the object file 396, controller 390 may output control signals causing carriage drive 378 (or slurry dispenser drive 352) to move slurry dispenser 350 and slurry leveler 370 across build volume 322. While slurry dispenser 350 is moved across build volume 322, controller 390 may output further control signals actuating pump 332 and valve 334 such that slurry from slurry reservoir 330 is dispensed through slurry dispenser 350 at a predetermined pressure and predetermined rate to control the thickness of the thus formed layer 54. The thickness of the formed layer may be further controlled by controller 390 outputting control signals causing leveler adjuster 372 to selectively raise and lower leveler 370. During such time, control signals from controller 390 may further actuate agitator 375 to vibrate or otherwise agitate leveler 370.

Following a sufficient lapse of time such that the layer 54 of slurry is sufficiently dried or settled, controller 390 may output control signals actuating solidifier 374 to solidify portions of the layer 54 in accordance with the previously determined 3D print points. This process is repeated for each layer of object 398. Upon completion of object 398, the object may be removed from build volume 322.

During times that dispenser 350 and leveler 370 are not being used, controller 390 may output control signals to carriage drive 378 causing carriage drive 378 to position dispenser 350 and leveler 370 opposite to service station 380 (as shown in broken lines). Carriage drive 378 may move the leveling surfaces 371 across wiper 382, cleaning such surfaces. Controller 390 may output control signals causing capper 384 to rise into sealing engagement with and over the dispensing aperture or apertures of dispenser 350. In implementations where slurry dispenser 350 is provided with a closable dispensing aperture, controller 390 may output control signals causing the aperture to be closed during those times that slurry dispenser 350 is not in use.

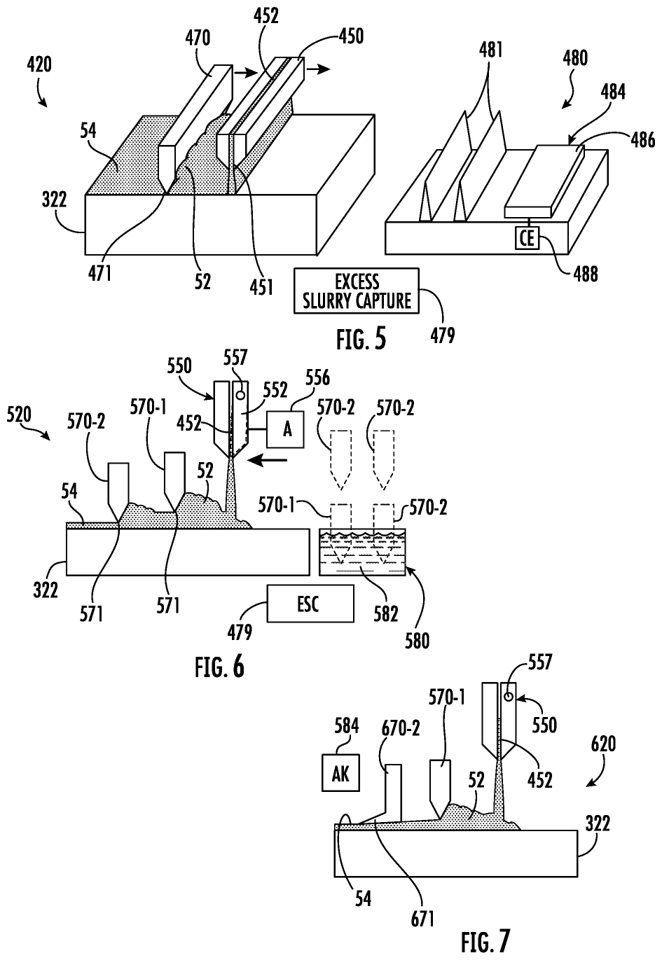

FIG. 5 is a perspective view illustrating portions of an example 3D printing system 420. System 420 is similar to system 320 except that system 420 is illustrated as specifically comprising slurry dispenser 450, slurry leveler 470, excess slurry capture 479 and service station 480. The remaining components of system 420 which correspond to components of system 320 are numbered similarly or are shown in FIG. 4. Slurry dispenser 450, slurry leveler 470, service station 480 are particular examples of slurry dispenser 350, slurry leveler 370 and service station 380, respectively.

As shown by FIG. 5, slurry dispenser 450 comprises an elongate body having a tapered nose 451 through which an elongate slot 452 extends. In some implementations, slot 452 has a length equal to the width of build volume 322. In other implementations, slot 452 may have a length less than the length of build volume 322. Slot 452 receives pressurized slurry from slot reservoir 330 S control by pump 332 and valve 334. Slurry dispenser 450 may be driven by carriage drive 378 as described above (or slurry dispenser drive 352 as described above).

Slurry leveler 470 comprises an elongate blade having a lower end that tapers to a leveling point 471. In some implementations, slurry leveler 470 is coupled to dispenser 450 so as to be moved across build volume 322 in unison with the movement of slurry dispenser 450. In other implementations, slurry leveler 470 may be independently moved across build volume 322. Slurry leveler 470 assists and providing a smooth and level layer 54 for being subsequently solidified to form a layer of the 3D object being printed.

Excess slurry capture 479 extends below a gap between service station 480 and build volume 322. Excess slurry capture 479 receives any excess slurry dispensed by dispenser 450 and pushed into the gap by leveler 470. Excess slurry capture 479 may comprise a waste receptacle or may comprise a chamber or passage through which the excess slurry may be returned and recycled for further use. For example, slurry within excess slurry capture 479 may be pumped back to slurry reservoir 330, with or without the addition of liquid, to compensate for any evaporation or drying that may have occurred.

Service station 480 is similar to service station 380 described above except that service station 480 is specifically illustrated as comprising a pair of wiping blades 481 and capper 484. Wiping blades 481 project above an underlying support to a height so as to interact with portions of slurry leveler 470 when slurry leveler 470 is moved across wiping blades 481 by carriage drive 378.

Capper 484 comprises an elastomeric or rubber-like sealing ring or pad 486 which may be selectively raised and lowered by capper elevator 488 (schematically illustrated). Elevator 488 comprises a lift actuator, such as electric solenoid, pneumatic cylinder-piston assembly or the like, that lifts pad 486 into sealing engagement with and across the lower end of slot 452 when dispenser 450 is positioned opposite to and over pad 486. As a result, drying of slurry within dispenser 450 is reduced when dispenser 450 is not being utilized. Prior to use of dispenser 450, capper elevator 48 may lower pad 486 out of engagement with dispenser 450, wherein carriage drive 378 may then locate dispenser 450 opposite to build volume 322 for dispensing another layer of slurry.

FIG. 6 is a sectional view of portions of an example 3D printing system 520. System 520 is similar to system 420 except that system 520 comprises slurry dispenser 550, slurry levelers 570-1, 570-2 (collectively referred to as slurry levelers 570) and service station 580 in place of slurry dispenser 450, slurry leveler 470 and service station 480, respectively. The remaining components of system 520 which correspond to components of system 420 are numbered similarly or are shown in FIGS. 4 and 5.

Slurry dispenser 557 is similar to dispenser 450 except that slurry dispenser 550 comprises a pivotable half 555 and actuator 556. Pivotable half 555 is pivotable about a pivot axis 557 between a slurry dispensing position and a closed position (shown in broken lines). In the closed position, half 555 closes off slot 452, reducing drying of slurry within dispenser 550. Actuator 556 controllably pivots half 555 about pivot axis 557 between the dispensing position and the closed position. Actuator 556 may comprise an electric solenoid, pneumatic or hydraulic cylinder-piston assembly or the like.

Slurry levelers 570 each comprise a slurry leveling blade tapering to a slurry leveling point 571. Each of slurry levelers 570 may be similar to slurry leveler 470 in size and shape. The slurry leveling points 571 of the different slurry levelers 570 are supported at different heights such that the mass of slurry 52 is leveled in a multistage process or operation. The provision of multiple slurry levelers 570 at different heights may provide finer control of the thickness of layer 54 and further compaction of layer 54.

Service station 580 is provided for servicing or cleaning levelers 570. In the example illustrated, service station 580 comprises an ultrasonic bath 582 into which levelers 570 may be lowered by leveler adjuster 372. Following cleaning or removal of any residue from levelers 570, levelers 570 may be lifted out of bath 582 and dried. In one implementation, service station 580 includes a liquid jet (not shown) to facilitate removal of slurry from the blade. In another implementation, service station 580 additionally includes an air knife 584 which may apply a burst of compressed air to facilitate such drying.

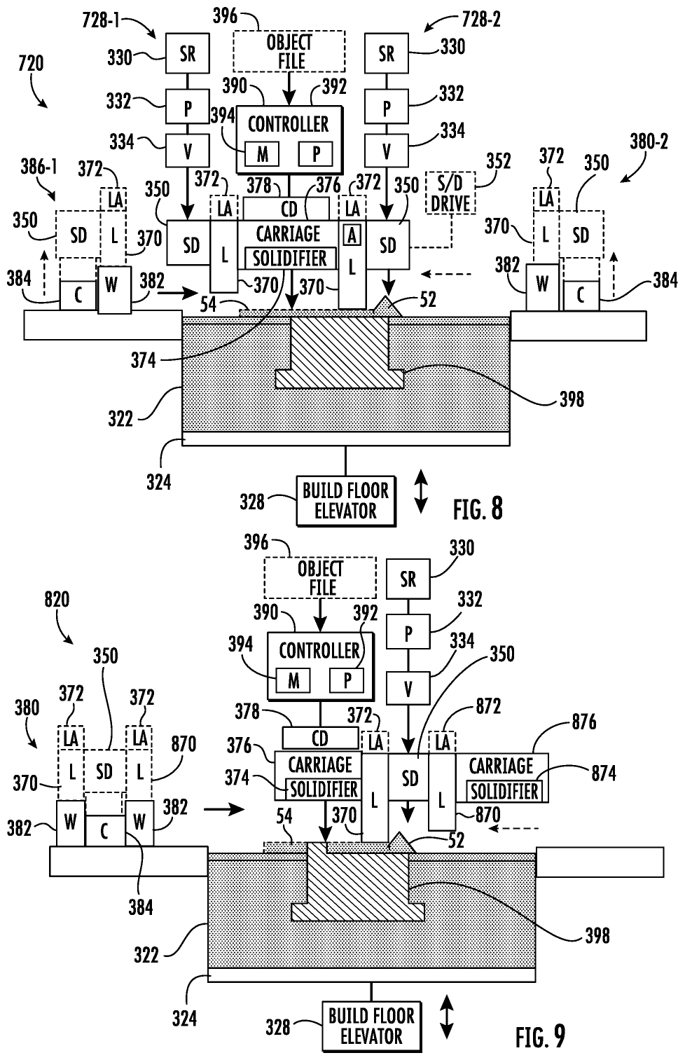

FIG. 7 is a diagram of a side of portions of an example 3D printing system 620. Printing system 620 similar printing system 520 described above except that system 620 comprises slurry leveler 670-2 in place of slurry leveler 570-2. The remaining components of system 620 which correspond to components of system 520 are numbered similarly or are shown in FIGS. 4 and 6.

Slurry leveler 670-2 comprises a leveling blade which terminates at a foot 671 rather than tapering to a point 571. Foot 671 may exert a normal force onto layer 54 to further compact layer 54. As indicated above, slurry leveler 670-2 may be provided with an agitator 375, such as an ultrasonic transducer or other vibration source to further compact layer 54.

FIG. 8 is a sectional view illustrating portions of an example 3D printing system 720. System 720 facilitates bidirectional layer generation across build volume 322. Printing system 720 is similar to 3D printing system 320 described above except that system 720 comprises slurry dispensing subsystems 728-1, 728-2 (collectively referred to as subsystems 728) on opposite sides of solidifier 374. The remaining components of system 720 which correspond to components of system 320 are numbered similarly.

Each of subsystems 728 comprise a slurry reservoir 330 (or a shared single slurry reservoir 330), a pump 332, a valve 334 and the slurry dispenser 350. When carriage drive 378 is moving carriage 376 to the right as seen in FIG. 8, slurry is dispensed from the slurry dispenser 350 of subsystem 728-2. During such movement to the right, slurry leveler 370 of subsystem 728-1 is raised out of contact with the dispensed slurry while slurry leveler 370 of subsystem 728-2 is lowered to a slurry leveling height. In contrast, when carriage drive 376 is moving carriage 376 to the left as seen in FIG. 8, slurry is dispensed from the slurry dispenser 350 of subsystem 728-1. During such movement to the left, slurry leveler 370 of subsystem 728-1 is lowered to a slower leveling height while slurry leveler 370 of subsystem 728 is raised out of contact with the dispensed slurry. As a result, 3D printing throughput may be enhanced.

In the example illustrated, system 720 further comprises two service stations 380: service station 380-1 and 380-2, on opposite sides of build volume 322. As a result, slurry dispenser 350 and slurry leveler 370 may be serviced in shorter time. In other implementations, one or both of service stations 380 may be omitted.

FIG. 9 is a sectional view illustrating portions of an example 3D printing system 820. As with system 720, system 820 facilitates bidirectional layer generation across build volume 322. System 820 is similar to system 320 described above except that system 820 comprises an additional slurry leveler 870 with the associated leveler adjuster 872 and an additional solidifier 874 supported by an associated carriage 876 on opposite side of slurry dispenser 350 as leveler 370 and solidifier 374. When carriage drive 378 is moving carriage 376 to the right as seen in FIG. 9 and as slurry is being dispensed from slurry dispenser 350, leveler 370 is lowered to a slurry leveling height while leveler 870 is raised position out of contact with the dispensed slurry. In contrast, when carriage drive 378 is moving carriage 376 to the left as seen in FIG. 8 and as slurry is being dispensed from the slurry dispenser 350, leveler 370 is raised out of contact with the dispensed slurry and leveler 870 is lowered to a slurry leveling height. As a result, 3D printing throughput may be enhanced.

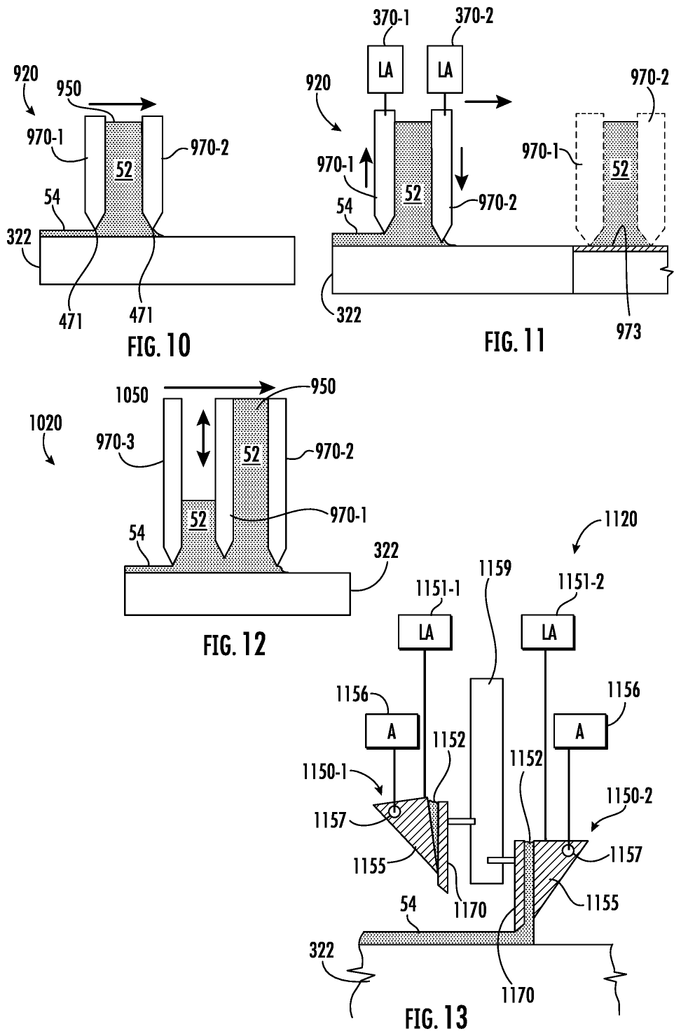

FIG. 10 is a sectional view illustrating portions of an example 3D printing system 920. System 920 is similar to system 820 described above except that slurry dispenser 350 and slurry levelers 370, 870 are integrated into a single unit. The remaining components of system 920 which correspond to components of system 820 are numbered similarly or are shown in FIG. 9. In some implementations, system 920 may omit the additional solidifier 874 and the additional carriage 876.

As shown by FIG. 10, system 920 comprises a pair of slurry leveling blades 970-1, 970-2 (collectively referred to as blades 970) which form internal sidewalls of the slurry passage of a slurry dispenser 950 for dispensing slurry 52. The pair of blades 970 create a dispensing reservoir that contacts the topmost layer of underlying build material within the build volume. The pair of blades 970 facilitates bidirectional coating or bidirectional layer generation, enhancing process throughput and more reliably attaining leveling tips or points 471 in contact with slurry 52.

As shown by FIG. 11, in some implementations, each of blades 970 may be independently raised and lowered by leveler adjuster, such as leveler adjusters 370 described above. In such implementations, the leveling blades 970 may be vertically raised and lowered to limit slurry leakage in front of the dispenser 950 as the dispenser 950 is moved across build volume 322. In some implementations, leveler 970-2 may be elevated to a height above leveler 970-1 during dispensing in the illustrated direction. As shown by broken lines, blades 370 may be moved over a compliant, elastomeric rubber or rubber-like surface 973 following a layer generation cycle to block the further flow of slurry 52 and seal the slurry dispensing to reduce drying of the slurry within or between blades 970 during those times that the slurry 52 is not being dispensed. Lower portions of the levelers may be fabricated with a range of blade angles or other contours.

FIG. 12 is a sectional view illustrating portions of an example 3D printing system 1020. System 1020 may provide a more uniform pressure at which slurry is dispensed to provide a more uniformity thickness of the coating or layer of slurry being formed across build volume 322. System 1020 is similar to system 920 described above except that system 1020 comprises an additional slurry leveling blade 970-3. The remaining components of system 1020 which correspond to components of system 920 are numbered similarly and/or are shown in FIGS. 9-11.

Slurry leveling blade 970-3 cooperates with slurry leveling blade 970-1 to form a trailing reservoir 1050, wherein the sensor 950 remains connected to the larger slurry reservoir 330 described above. Trailing reservoir 1050 is supplied with slurry that passes underneath the now intermediate slurry leveling blade 970-1. By adjusting the height of blade 970-1 with leveler adjuster 370-1 (shown in FIG. 11), the level of slurry 52 in reservoir 1050 may be maintained at a constant height. As a result, a control loop may be implemented that maintains level automatically so that slurry pressure under the trailing leveling blade 970-3 is invariant. Such a more constant pressure of the slurry beneath blade 970-3 may enhance uniformity of the thickness and packing density of the layer 54. In some implementations, leveler 970-2 may be raised to a height above leveler 970-1 to provide a stepped or staged metering.

FIG. 13 is a sectional view of portions of an example 3D printing system 1120 having mirroring slurry dispensers 1150-1, 1150-2 (collectively referred to as dispensers 1150). Dispensers 1150 may be employed in any of the above described 3D printing systems in place of the dispenser and leveler. Dispensers 1150 are connected to a slurry reservoir 330 that independently and selectively supplies a slurry of build maternal and liquid to one of the dispensers 1150 using a pump 332 and an intermediate valve 334 (each of which is shown in FIG. 4).

Each of dispensers 1150 comprises an elongate slot 1152 defined by a surface of leveler blade 1170 and an interior surface of pivotable half 1155. Slurry is pumped from reservoir 330 and passes through elongate slot 1152 and is discharged through a discharge aperture 1154 onto an underlying build volume 322 (shown above). In the illustrated example, the leading and trailing faces of slot 1152 are fixed at different elevations.

In the example illustrated, the slot length (distance between the leading and trailing slot faces) is about 50 to 250 micrometers, and the slot height (distance between slot exit and upper end of slot) may be in the range between 1 mm and 30 mm. In other implementations, slot length and/or slot height may vary depending on slurry rheology, slurry pressure, and coating rate.

In the example illustrated, each of dispensers 1150 comprises pivotable half 1155 and actuator 1156. Pivotable half 1155 is pivotable about a pivot axis 1157 between a slurry dispensing position and a closed position. FIG. 13 illustrates dispenser 1150-1 with half 1155 in a closed position and dispenser 1150-2 with half 1155 in an open, dispensing position. In the closed position, half 1155 closes off slot 1152, reducing drying of slurry within dispenser 550. Actuator 1156 controllably pivots half 1155 about pivot axis 1157 between the dispensing position and the closed position. Actuator 1156 may comprise an electric solenoid, pneumatic or hydraulic cylinder-piston assembly or the like.

In the example illustrated, dispensers 1150 are supported back-to-back so as to mirror one another to facilitate bidirectional layer formation. Dispensers 1150 are selectively supplied with slurry depending upon the direction of translation across the build volume. During dispensing of slurry as dispensers 1150 are moving in a direction across the build volume, the inactive trailing dispenser 1150 is elevated above the height of the leading dispenser 1150 so as to not interfere with the leveling of the layer of dispensed slurry by the active leading dispenser 1150. In the example illustrated, each of dispensers 1150 is associated with a lift actuator 1151-1, 1151-2 (schematically illustrated) such as electric solenoid, hydraulic/pneumatic cylinder-piston assembly, motor driven rack and pinion arrangement or the like, to selectively controllably raise and lower each of such dispensers 1150 along a vertical guide bar 1159 depending upon the direction in which dispensers 1150 are moved across the build volume and which of dispensers 1150 is active.

In some implementations, the inactive trailing dispenser 1150 is further plugged or closed to prevent leakage. For example, actuator 1156 may be actuated to pivot the pivotable half 1155 to close the associated slot 1152. In some implementations, an intermediate portion of the slot 1152 may be plugged or closed such that capillary forces retain slurry within slot to inhibit leakage. Such bidirectional layer formation may facilitate higher 3D printing productivity.

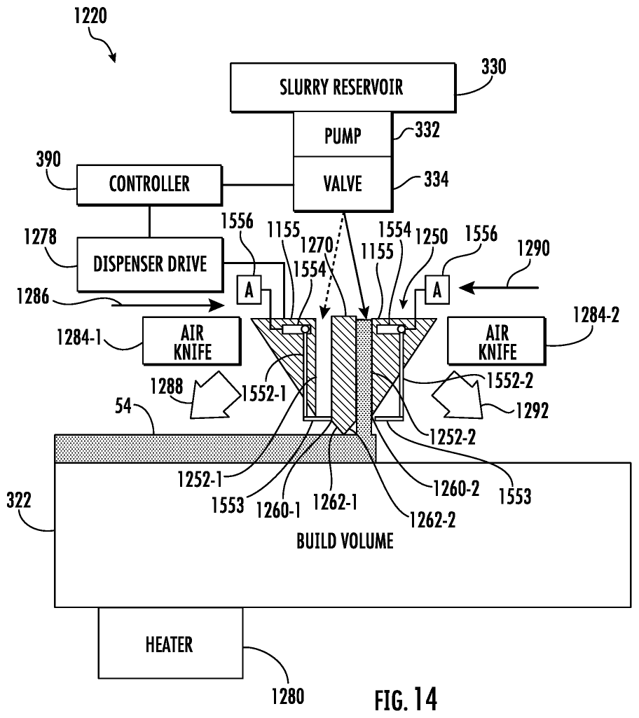

FIG. 14 is a sectional view illustrating portions of an example 3D printing system 1220. System 1220 is similar to system 4 described above except that system 1220 comprises bidirectional slurry dispenser 1250, dispenser drive 1278, heater 1280 and air knives 1284-1, 1284-2 (collectively referred to as air knives 1284. Those remaining components of system 1220 which correspond to components of system 320 are numbered similarly in FIG. 14 and/or are shown in FIG. 4.

Bidirectional slurry dispenser 1250 is similar to mirroring slurry dispensers 1150 except that bidirectional slurry dispenser 1250 comprises a single integrated dispenser having a pair of elongate slots 1252-1, 1252-2 (collectively referred to as slots 1252) that share an intermediate blade 1270. Bidirectional slurry dispenser 1250 further comprises slot cappers 1552-1, 1552-2 (collectively referred to as cappers 1552) for selectively blocking, plugging or capping slots 1252-1 and 1252-2, respectively. Slot 1252-1 has a leading slot edge or face 1260-1 and a trailing slot edge or face 1262-2. Slot 1252-2 has a leading slot edge or face 1260-2 and a trailing slot edge or face 1262-2. The leading slot faces 1260-1, 1260-2 are elevated above their respective trailing slot faces 1262-1, 1252-2. Each of slots 1252 is supplied with a slurry of build material and liquid under the control of valve 334 and controller 390 depending upon the direction of travel of dispenser 1250 across build volume 322 as driven by dispenser drive 1278.

In the example illustrated, the slot length (distance between the leading and trailing slot faces) is about 50 to 250 micrometers, and the slot height (distance between slot exit and upper end of slot) typically is in the range between 1 mm and 30 mm. in other implementations, slot length and/or slot height may vary depending on slurry rheology, slurry pressure, and coating rate.

Slot cappers 1552 comprise arms that support rubber-like or elastomeric pads 1553 for extending across and sealing a mouth of their respective slots 1252. Slot cappers 1552 are each movable between a slot capping position (shown with respect to slot 1252-1) and a withdrawn position (shown with respect to slot 1252-2) which opens the respective slot for dispensing slurry. In the example illustrated, each of slot cappers 1552 is translatable or slidable within a slot 1554 formed within half 1155 (which is not pivotable). Actuators 1556 drive their respective slot cappers 1552 along slots 1554 between the slot capping position and the withdrawn position. In other implementations, slot cappers 1552 may alternatively pivot between the illustrated slot capping position and withdrawn position.

Dispenser drive 1278 drives dispenser 1250 across build volume 322. In one implementation, dispenser drive 1278 may comprise carriage drive 378 or a similar drive mechanism.

Heater 1280 comprises a device that heats the build material within build volume 322. Heater 1280 may facilitate the removal or evaporation of the liquid from the layer 54 applied by dispenser 1250. In one implementation, heater 1280 may comprise electrical resistors that emit heat upon conducting electrical current. In some implementations, the application of heat by heater 1280s controlled by controller 390 based upon the moisture content of layer 54, the current rate of airflow provided by air knives 1284 and the rate at which slurry is dispensed by dispenser 1250 under the control of valve 334 and pump 332. In some implementations, heater 1280 may be omitted. As should be appreciated, each of the above described build volumes may be provided with a heater similar to heater 1280.

Air knives 1284 apply a stream of air or a stream of heated air to newly applied layer 54 to assist in drying the applied layer 54 so as to ready the layer 54 for subsequent solidification by solidifier 374 (shown and described with respect to FIG. 4). Each of air knives 1284 may comprise an elongate slot or a series of nozzles which direct air towards the newly applied layer 54. In some implementations, air knives 1284 may be coupled to the dispenser 1250 for movement with the dispenser 1250. In some implementations, air knives 1284 may be coupled to the build material solidifier for movement with the build material solidifier or may be moved by a separate carriage and drive that independently locates the air knives 1284.

Controller 390 controls the formation of the layer 54 in build volume 322. In the example illustrated, controller 390 is depicted as outputting control signals causing dispenser drive 1278 to drive or translate dispenser 1250 in the direction indicated by arrow 1286 across build volume 322. Operation of dispenser 1250 varies depending upon the direction which dispenser 1250 is being moved, which of slots 1252 is a leading slot and which of slots 1252 is a trailing slot. The “leading slot” refers to slot 1252 currently closest to the side of the build volume towards which dispenser 1250 is currently being moved. In the example illustrated in which dispenser 1250 is being moved in the direction indicated by arrow 1286 across build volume 322, slot 1252-2 is the leading slot.

Controller 390 outputs control signals causing valve 334 to direct the slurry from slurry reservoir 330, as pressurized by pump 332, to slot 1252-2. Controller 390 may further output control signals causing control knife 1284-1 to direct a stream of air 1288, sometimes heated, towards the newly dispensed layer 54 to facilitate evaporation and drying of layer 54. Controller 390 further outputs control signals causing the inactive trailing slot of the dispenser 1250 to be plugged or closed to inhibit leakage. For example, controller 390 may output control signals causing actuator 1556 to translate slot capper 1552-1 to the slot capping position shown to close the inactive trailing slot 1252-1. In some implementations, controller 390 may further up control signals causing heater 1282 apply heat to the material within build volume 322 to further assist in the drying of layer 54. The thus formed layer 54 may continuously extend, without interruption, across a majority if not all of a width of build volume 322, wherein the “width” is the dimension of build volume 322 extending in a direction perpendicular to the direction in which dispenser 1250 is driven across build volume 322.

When a next layer is to be deposited upon the previous layer 54, dispenser 1250 may be driven in an opposite direction across build volume 322, facilitating the formation of the next build layer without dispenser 1250 having to be returned to its initial position on the left side of build volume 322. During formation of the next layer, controller 390 may output control signals causing dispenser drive 1278 to drive or translate dispenser 1250 in the direction indicated by arrow 1290 across build volume 322. Controller 390 further outputs control signals causing valve 334 to direct the slurry from slurry reservoir 330, as pressurized by pump 332, to slot 1252-1, discontinuing the supply of slurry to slot 1252-2. Controller 390 may further output control signals causing control knife 1284-2 to direct a stream of air 1292, sometimes heated, towards the newly dispensed next layer to facilitate evaporation and drying of the next layer.

In some implementations, controller 390 may further up control signals causing heater 1282 apply heat to the material within build volume 322 to further assist in the drying of next build layer. Although bidirectional dispenser 1250 and air knives 1284 are illustrated as being employed in system 1220, bidirectional dispenser 1250 may be employed in any of the above described 3D printing systems in place of the described slurry dispensers. It should be appreciated that air knife 1284 and heater 1280 may likewise be employed in any of the above described 3D printing systems.

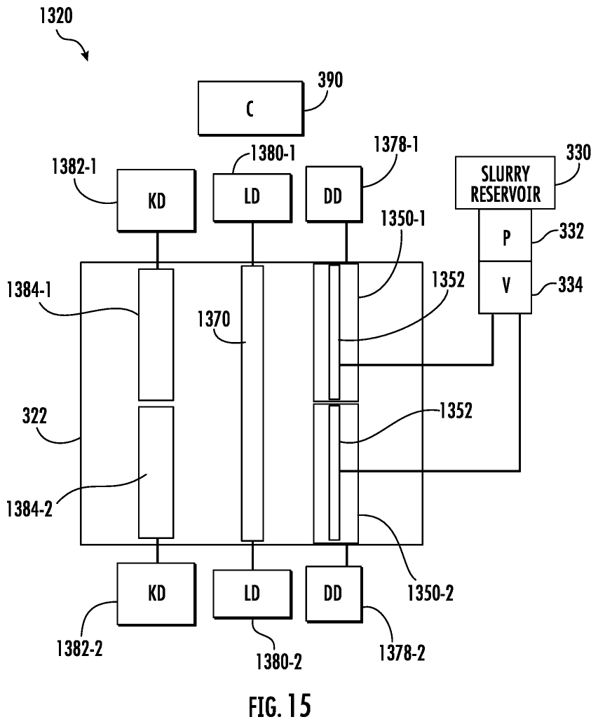

FIG. 15 is a top view schematically illustrating portions of an example 3D printing system 1320. System 1320 is similar to system 320 described above except that system 1320 comprises multiple slurry dispensers 1350-1, 1350-2 (collectively referred to as slurry dispensers 1350) that collectively span the width of the build volume 322. As shown by FIG. 15, slurry leveler 1370 continuously and without interruption extends across substantially the entire width of build volume 322. Those remaining components of system 1320 which correspond to components of system 320 are numbered similarly and/or are shown in FIG. 4.

In the example illustrated, system 1320 further comprises multiple air knives 1384-1, 1384-2 (collectively referred to as air knives 1384) that collectively span the width of build volume 322. Each of the individual slurry dispensers 1350, slurry levelers 1370 and knives 1384 is independently movable across build volume 322 by an associated drive. Dispensers 1350-1, 1350-2 are movable in either direction across build volume 322 by dispenser drives 1378-1 and 1378-2, respectively. Slurry leveler 1370 is movable in either direction across build volume 322 by leveler drives 1380. Knives 1384-1, 1384-2 are movable in either direction across build volume 322 by knife drives 1382-1, 1382-2, respectively.

Slurry dispensers 1350 may comprise any of the above described slurry dispensers. Each of such slurry dispenser 1350 comprises a slot 1352 which is controllably supplied with slurry from slurry reservoir 330 by pump 332 and valve 334. The operation of pump 332 and valve 334 as well as the operation of the individual drives 1378, 1380 and 1382 may be under the control of controller 390. Following the formation of a layer of slurry in build line 322, controller 390 may position and cause air knives 1384 to sufficiently dry the layer of slurry prior to selected portions of the layer being solidified by solidifier 374 (shown in FIG. 4) as described above.

In some implementations, slurry dispensers 1350 may be in the form of slurry dispenser 1250 described above. In such an implementation, slurry leveler 1370 and associated leveler drives 1380 may be omitted. Although system 1320 is illustrated as comprising two dispenser 1350 and two knives 1384, in other implementations, system 1320 may comprise any number of dispensers 1378 that collectively span a majority if not all of the width of build volume 322 and any number of knives 1384 that collectively span a majority if not all of the width of build volume 322. The relative number of dispensers and other stuff on the and the relative number of air knives may be unequal.

Each of the above described 3D printing systems facilitates use of a wider array of build material particles having a wide array of sizes and shapes. Each of the above described 3D printing systems may reduce such particles from becoming airborne. In addition, the disclosed example 3D printing systems may fully enclose the slurry until the point of delivery, reducing fluid loss caused by evaporation. Because the slurry dispensers are moved across the build volume, more constant slurry properties are maintained across the build volume. The thickness of the layer of slurry may be more actively controlled through the use of a slurry leveler. As demonstrated above, some of the disclosed 3D printing systems may carry out bidirectional build material layer generation, increasing printer throughput.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A three-dimensional (3D) printing system comprising:
a build volume;
a slurry reservoir to contain a slurry of build material and liquid;
a slurry dispenser to receive the slurry from the slurry reservoir and movable in a direction across the build volume to dispense slurry across the build volume.

2. The system of claim 1 further comprising a slurry leveler movable across the build volume to level slurry dispensed into the build volume.

3. The system of claim 2 further comprising a service station to carry out a servicing operation, the servicing operation selected from a group of servicing operations consisting of: capping an outlet of the slurry dispenser, cleaning the slurry leveler and combinations thereof.

4. The system of claim 2, wherein the slurry leveler is vertically movable.

5. The system of claim 2, wherein the slurry dispenser comprises an elongate slot and wherein the slurry leveler forms a side of the elongate slot.

6. The system of claim 5 further comprising a second slurry leveler opposite the slurry leveler and forming a second side of the elongate slot, the second slurry leveler being vertically movable.

7. The system of claim 1, wherein the dispenser comprises a first elongate slot, the system further comprising a second elongate slot through which slurry is dispensed into the build volume, the elongate slot spanning a first portion of a dimension of the build volume perpendicular to the direction and the second elongate slot spanning a second portion of the dimension of the build volume.

8. The system of claim 7, further comprising a second slurry dispenser, the slurry dispenser comprising the elongate slot and the second slurry dispenser comprising the second elongate slot.

9. The system of claim 1, wherein the slurry dispenser is actuatable between a closed state and a slurry dispensing state.

10. The system of claim 1, wherein the slurry dispenser comprises an elongate slot through which slurry is dispensed into the build volume.

11. The system of claim 1, wherein the slurry dispenser comprises an elongate slot having a leading face elevated above a trailing face.

12. The system of claim 1, wherein the slurry dispenser comprises a bidirectional dispenser comprising a first slot having a first leading face elevated above a first trailing face and a second slot having a second leading face elevated above a second trailing face, the first slot and the second slot sharing a blade therebetween that provides the first trailing face and the second trailing face.

13. The system of claim 1 further comprising an air knife movable across the build volume.

14. A three-dimensional (3D) printing method comprising:
moving a slurry dispenser to different locations opposite a build volume;
dispensing a slurry of build material and liquid from the slurry dispenser at the different locations; and
leveling the slurry to form a layer of slurry across the build volume.

15. A three-dimensional (3D) printing system comprising:
a build volume;
a slurry reservoir to contain a slurry of build material and liquid;
a slurry dispenser to receive the slurry from the slurry reservoir and movable in a direction across the build volume to dispense slurry across the build volume;
a slurry leveler movable across the build volume to level slurry dispensed into the build volume;
a build material solidifier; and
a controller to receive a file for a three-dimensional object to be printed and to control the build material solidifier, the slurry dispenser and the slurry leveler based upon the file.
